(19) United States
(12) Patent Application Publication
(10) Pub. No.: US 2013/0302032 A1
(43) Pub. Date: Nov. 14, 2013

(54) OPTICAL MULTIPLEXER / DEMULTIPLEXER

(71) Applicant: SUMITOMO ELECTRIC INDUSTRIES, LTD., Osaka (JP)

(72) Inventor: Osamu SHIMAKAWA, Yokohama-shi (JP)

(21) Appl. No.: 13/864,533

(22) Filed: Apr. 17, 2013

Related U.S. Application Data
(60) Provisional application No. 61/640,815, filed on May 1, 2012.

(30) Foreign Application Priority Data
Apr. 20, 2012 (JP) 2012-096750

(51) Int. Cl. H04J 14/02

(52) U.S. Cl. CPC H04J 14/02
USPC 398/48

(57) ABSTRACT

An optical multiplexer/demultiplexer includes a first fiber unit having an MCF and a GRIN lens, a second fiber unit having an MCF and a GRIN lens, and an optical filter. The optical filter is disposed between the GRIN lens of the first fiber unit and the GRIN lens of the second fiber unit and makes transmitted light and reflected light emitted from a core of the MCFs incident on a core of the MCFs. A leading end of the MCF and one end of the GRIN lens are held in contact with each other in the first fiber unit, while a leading end of the MCF and one end of the GRIN lens are held in contact with each other in the second fiber unit.

### CROSS-REFERENCE RELATED APPLICATIONS

This application claims priority to Provisional Application Ser. No. 61/640,815, filed on May 1, 2012 and claims the benefit of Japanese Patent Application No. 2012-096750, filed on Apr. 20, 2012, all of which are incorporated herein by reference in their entirety.

### BACKGROUND OF THE INVENTION

1. Field of the Invention

The present invention relates to an optical multiplexer/demultiplexer and, in particular, to an optical multiplexer/demultiplexer used for optical communications.

2. Related Background Art

For providing an FTTH (Fiber To The Home) service which enables optical communications between one broadcasting station and a plurality of subscribers, a so-called PON (Passive Optical Network) system in which the subscribers share one optical fiber through an optical splitter has conventionally been actualized. For multiplexing/demultiplexing wavelengths of light, WDM filter modules have been used in the PON system (see, for example, Japanese Patent Publication No. 4002144). Under such circumstances, a triple play service which collectively provides video, telephone, and the Internet has now been spreading rapidly. An optical access system B-PON (Broadband-Passive Optical Network), which is a kind of PON, uses WDM filter modules for multiplexing/demultiplexing video and IP signals of telephone, the Internet, and the like.

### SUMMARY OF THE INVENTION

The above-mentioned WDM filter modules are provided on the station side and subscriber side in the optical access system B-PON. As the amount of information transfer increases, congestion of lines has been becoming problematic in particular on the station side. As a countermeasure, a multicore fiber (MCF) in which one fiber is provided with a plurality of cores has been under study for practical use. However, the conventional WDM filter modules have been presupposed to connect with single-core fibers and cannot connect with multicore fibers.

The optical multiplexer/demultiplexer in accordance with the present invention comprises a first fiber unit having a first multicore fiber and a first refractive-index-distribution-type optical component, a second fiber unit having a second multicore fiber and a second refractive-index-distribution-type optical component, and an optical filter disposed between the first refractive-index-distribution-type optical component of the first fiber unit and the second refractive-index-distribution-type optical component of the second fiber unit. The optical filter is configured to make at least one of transmitted light or reflected light emitted from a core of the first multicore fiber incident on a core of the first or second multicore fiber. A leading end of the first multicore fiber and one end of the first refractive-index-distribution-type optical component are held in contact with each other in the first fiber unit, while a leading end of the second multicore fiber and one end of the second refractive-index-distribution-type optical component are held in contact with each other in the second fiber unit.

In this optical multiplexer/demultiplexer, the leading end of the first multicore fiber and one end of the first refractive-index-distribution-type optical component are held in contact with each other in the first fiber unit, while the leading end of the second multicore fiber and one end of the second refractive-index-distribution-type optical component are held in contact with each other in the second fiber unit. The optical filter is disposed between the first and second fiber units thus brought into contact with each other. Such a structure makes it possible to apply the optical multiplexer/demultiplexer to multicore fibers.

In this optical multiplexer/demultiplexer, the leading end of the multicore fiber and the one end of the refractive-index-distribution-type optical component are held in contact with each other in each fiber unit. In this case, a beam emitted from the multicore fiber is securely made incident on the optical component on the refractive index distribution side, whereby the reflection loss of the beam can be reduced between the leading end of the multicore fiber and the one end of the refractive-index-distribution-type optical component. Thus reducing the reflecting beam can favorably inhibit the reflected beam from returning to the system emitting the same and thereby becoming noises which affect the whole system.

In the above-mentioned optical multiplexer/demultiplexer, the first multicore fiber and first refractive-index-distribution-type optical component may have the same outer diameter. This makes it easy for the first multicore fiber and first refractive-index-distribution-type optical component to align their axes with each other.

In the above-mentioned optical multiplexer/demultiplexer, the leading end of the first multicore fiber and the one end of the first refractive-index-distribution-type optical component may be firmly attached to each other. In this case, the leading end of the first multicore fiber and the one end of the first refractive-index-distribution-type optical component may be fusion-spliced to each other. This can securely bring the first multicore fiber and the first refractive-index-distribution-type optical component into contact with each other and restrain them from shifting from each other when in use, for example. The second multicore fiber and the second refractive-index-distribution-type optical component may be firmly attached or fusion-spliced to each other similarly.

In the above-mentioned optical multiplexer/demultiplexer, the first multicore fiber may have a core diameter greater in the end part in contact with the first refractive-index-distribution-type optical component than in the other part. This makes the core diameter greater in the end part to become the light entrance end, whereby the optical axis alignment for making light securely incident can be effected easily without making the optical multiplexer/demultiplexer so large as a whole. Here, the core diameter of the contact end of the first multicore fiber may be expanded by heat treatment at the time of fusion-splicing the first multicore fiber to the first refractive-index-distribution-type optical component as mentioned above or by other treatment.

In the above-mentioned optical multiplexer/demultiplexer, the optical filter may be held between the first and second refractive-index-distribution-type optical components under pressure, so as to adjust a transmission characteristic.

The above-mentioned optical multiplexer/demultiplexer may further comprise a connector configured to hold the first and second fiber units, while the connector may have an elastic holding mechanism that elastically holds the first and second fiber units facing each other under pressure. In this case, the optical filter may be adjusted beforehand so as to attain a desirable spectrum by a transmission or reflection spectral shift caused by a spring pressure of the elastic holding mechanism.

In the above-mentioned optical multiplexer/demultiplexer, a plurality of cores in the first multicore fiber may be arranged symmetrically about a center axis of the multicore fiber, a pair of the symmetrically arranged cores having a pitch therebetween identical to that between the cores in another pair. In this case, rotating the multicore fibers holding the optical filter therebetween about the center axis can provide the optical multiplexer/demultiplexer with a function of an optical switch.

In the above-mentioned optical multiplexer/demultiplexer, a plurality of cores in the first multicore fiber may be arranged symmetrically about the center axis of the multicore fiber, a pair of the symmetrically arranged cores having a pitch therebetween different from that between the cores in another pair. This prevents a beam from a pair of cores from being made incident on another core, for example.

The present invention will be more fully understood from the detailed description given herein below and the accompanying drawings, which are given by way of illustration only and are not to be considered as limiting the present invention.

Further, scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will be apparent to those skilled in the art from this detailed description.

### BRIEF DESCRIPTION OF THE DRAWINGS

FIG. 1 is a schematic structural diagram schematically illustrating a cross-sectional structure of the optical multiplexer/demultiplexer in accordance with a first embodiment;

FIGS. 2A and 2B are a set of diagrams illustrating cross-sectional structures of multicore fibers in the optical multiplexer/demultiplexer depicted in FIG. 1, in which FIG. 2A and FIG. 2B are partial sectional views taken along the lines II(a)-II(a) and II(b)-II(b), respectively;

FIGS. 3A and 3B are a set of diagrams for illustrating a case using three sets of multicore fibers in the optical multiplexer/demultiplexer depicted in FIG. 1;

FIG. 4 is a diagram illustrating a modified example of core arrangement in the multicore fiber;

FIGS. 5A and 5B are a set of diagrams illustrating a method of manufacturing the optical multiplexer/demultiplexer depicted in FIG. 1;

FIG. 6 is a diagram schematically illustrating how light transmittance changes when an optical filter is pressed;

FIGS. 7A and 7B are a set of diagrams illustrating another method of manufacturing the optical multiplexer/demultiplexer depicted in FIG. 1;

FIGS. 8A and 8B are a set of diagrams illustrating a method of manufacturing the optical multiplexer/demultiplexer in accordance with a second embodiment;

FIGS. 9A to 9C are a set of diagrams illustrating a method of manufacturing the optical multiplexer/demultiplexer in accordance with a third embodiment; and

FIG. 10 is a schematic explanatory diagram schematically illustrating a modified example of the optical multiplexer/demultiplexer.

### DESCRIPTION OF THE PREFERRED EMBODIMENTS

In the following, embodiments of the present invention will be explained in detail with reference to the accompanying drawings. In the explanation, the same constituents or those having the same functions will be referred to with the same signs while omitting their overlapping descriptions.

### First Embodiment

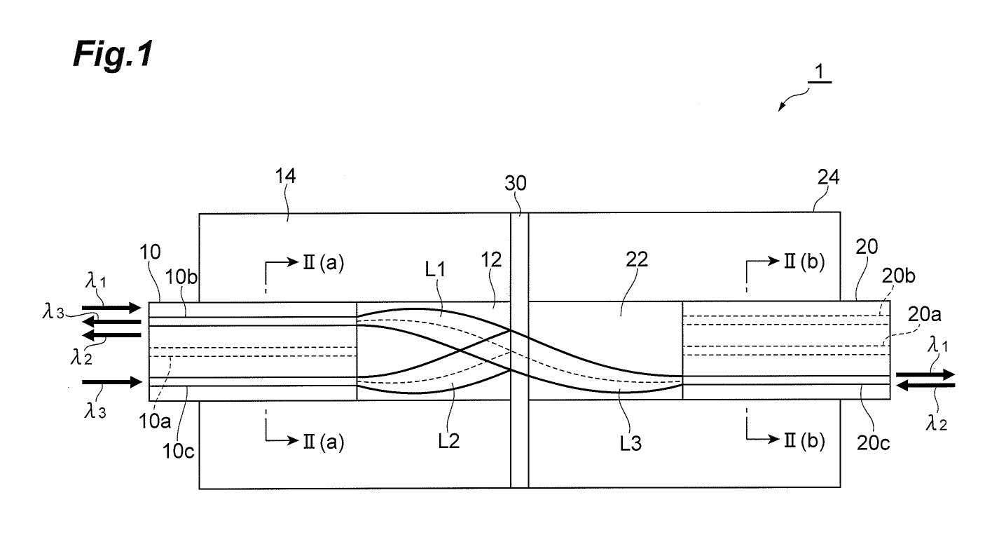

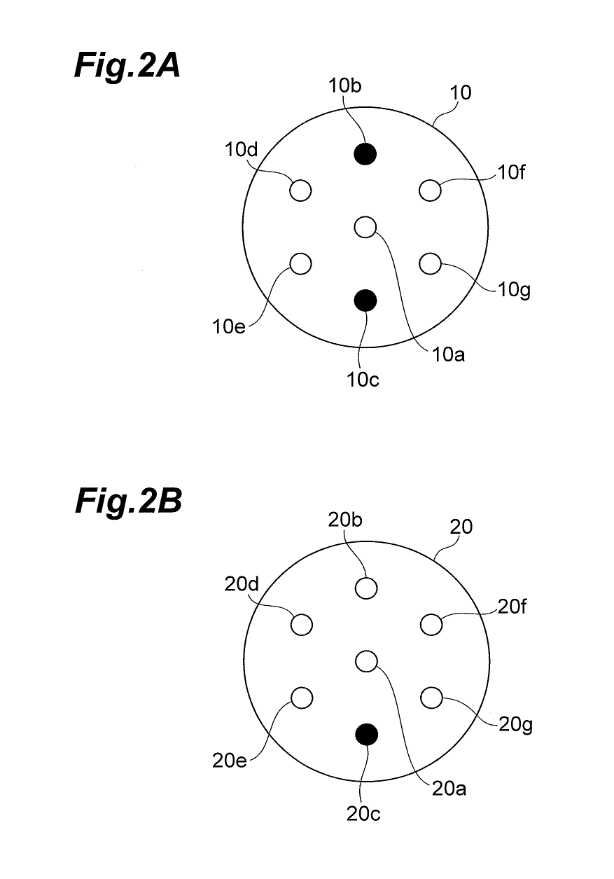

First, an optical multiplexer/demultiplexer 1 in accordance with the first embodiment of the present invention will be explained with reference to FIGS. 1, 2A and 2B.

As illustrated in FIG. 1, the optical multiplexer/demultiplexer 1 is a WDM filter module for multiplexing/demultiplexing video and IP signals in an optical access system B-PON, for example. The optical multiplexer/demultiplexer 1 comprises multicore fibers (hereinafter referred to as MCFs) 10, 20; GRIN lenses 12, 22 (refractive-index-distribution-type optical components); ferrules 14, 24; and an optical filter 30.

The MCF 10 is an optical fiber in which a plurality of cores are arranged such that their optical axes are parallel to each other within the same cladding. As illustrated in FIG. 2A, the plurality of cores in the MCF 10 are arranged two-dimensionally so as to exhibit a constant core-to-core distance, such that seven cores in total including one (core 10a) at the center position of the cladding and six cores (10b to 10g) arranged thereabout at intervals of 60° are equidistant from each another. The cores 10b to 10g are arranged symmetrical about the core 10a, so that three pairs of cores 10b, 10c; 10d, 10g; and 10e, 10f are formed.

In the MCF 10, the cores adjacent to each other have the same distance therebetween, an example of which is about 0.045 mm. The cladding diameter (outer diameter) of the MCF 10 is about 0.15 mm, for example.

The GRIN lens 12, which is a lens whose refractive index changes radially as a function of radius, converges a beam transmitted therethrough at a predetermined location by adjusting the lens length. The outer diameter of the GRIN lens 12 is the same as that of the MCF 10. The GRIN lens 12 has one end in contact with the leading end of the MCF 10, while the MCF 10 and the GRIN lens 12 are firmly attached to each other by fusion splicing. The contact by fusion splicing forms no air layer between the MCF 10 and the GRIN lens 12.

The outer diameter of the GRIN lens 12, which is the same as that of the MCF 10 here, may be changed when appropriate as long as light from the MCF 10 does not reach the outermost circumference of the lens. A GI fiber (Graded Index Fiber) may be used in place of the GRIN lens 12. The outer diameter of the GI fiber can also be changed when appropriate as long as light from the MCF 10 falls within the core region of the GI fiber.

When the MCF 10 and the GRIN lens 12 are spliced by fusion to each other, a dopant (e.g., germanium) in the cores of the MCF 10 may diffuse into the cladding because of the heating at the time of fusion and the like, thereby slightly enhancing the MFD (Mode Field Diameter). This phenomenon causes the MCF 10 to make the core diameter substantially larger in the contact end part (fusion end part) with the GRIN lens 12 than in the other part. In this case, enhancing the MFD improves tolerance to axial misalignment of the MCF 10.

The ferrule 14 has a hollow cylindrical form and holds therewithin the MCF 10 and GRIN lens 12 fusion-spliced to each other. Thus arranged MCF 10, GRIN lens 12, and ferrule 14 constitute a first fiber unit.

As with the MCF 10, the MCF 20 is an optical fiber in which a plurality of cores are arranged such that their optical axes are parallel to each other within the same cladding. As illustrated in FIG. 2B, the plurality of cores in the MCF 20 are arranged two-dimensionally so as to exhibit a constant core-to-core distance, such that seven cores in total including one (core 20a) at the center position of the cladding and six cores (20b to 20g) arranged thereabout at intervals of 60° are equidistant from each another. The cladding diameter and the like of the MCF 20 are the same as those of the MCF 10.

As with the GRIN lens 12, the GRIN lens 22, which is a lens whose refractive index changes radially as a function of radius, converges a beam transmitted therethrough at a predetermined location by adjusting the lens length. The outer diameter of the GRIN lens 22 is the same as that of the MCF 20. The GRIN lens 22 has one end in contact with the leading end of the MCF 20, while the MCF 20 and the GRIN lens 22 are firmly attached to each other by fusion splicing. The contact by fusion splicing in the GRIN lens 22 also forms no air layer between the MCF 20 and the GRIN lens 22.

The ferrule 24 has a hollow cylindrical form and holds therewithin the MCF 20 and GRIN lens 22 fusion-spliced to each other.

Thus arranged MCF 20, GRIN lens 22, and ferrule 24 constitute a second fiber unit.

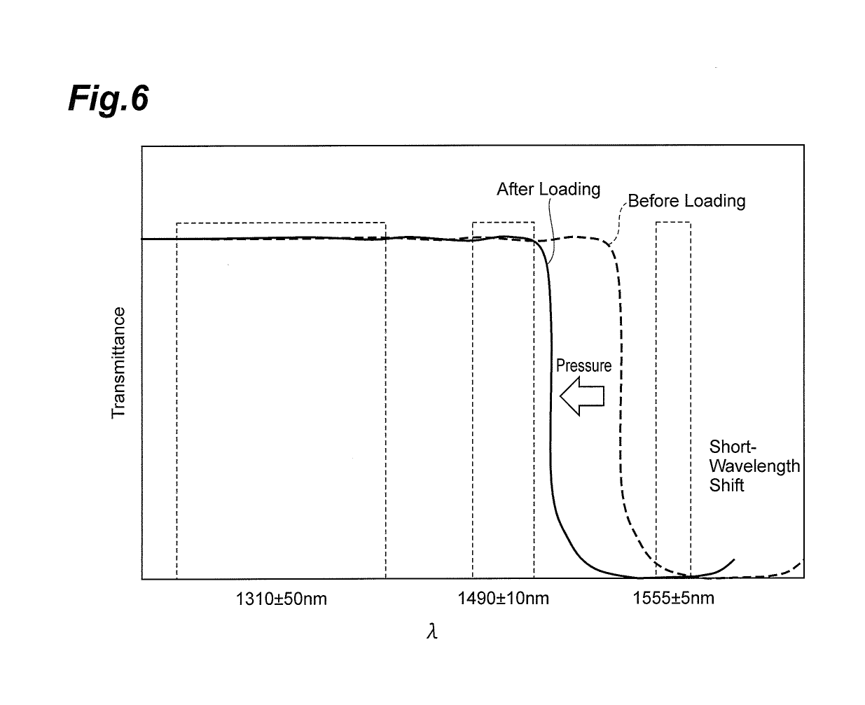

The optical filter 30 is a multilayer filter which transmits therethrough predetermined wavelengths (e.g., λ1 and λ2) but reflects another wavelength (e.g., λ3). The optical filter 30 is arranged between the GRIN lens 12 constituting the first fiber unit and the GRIN lens 22 constituting the second fiber unit. Specifically, the WDM filter 30 is connected to an end face of the first fiber unit by vapor deposition and to the second fiber unit with an adhesive. As the adhesive, a light-transmitting optical adhesive can be used as appropriate. The optical filter 30 constituted by a multilayer film has such a characteristic as to be able to shift a light-transmitting wavelength band by applying a pressure to its stacking surface as will be explained later (see FIG. 6).

In thus constructed optical multiplexer/demultiplexer 1, light having a wavelength λ1 (e.g., 1310 nm) incident on the core 10b of the MCF 10 is transmitted through the optical filter 30 so as to enter the core 20c of the MCF 20 of the second fiber unit as light L1, L3, while light having a wavelength λ2 (e.g., 1490 nm) incident on the core 20c of the MCF 20 is transmitted through the optical filter 30 so as to enter the core 10b of the MCF 10 of the first fiber unit as light L3, L1. On the other hand, in the optical multiplexer/demultiplexer 1, light having a wavelength λ3 (e.g., 1550 nm) incident on the core 10c of the MCF 10 is reflected by the optical filter 30 so as to enter another core 10b of the MCF 10. That is, the cores 10b, 10c of the MCF 10 form a pair of cores to which the core 20c of the MCF 20 corresponds; these cores are delineated by solid lines in FIG. 1 and painted black in FIGS. 2A and 2B.

When thus constructed optical multiplexer/demultiplexer 1 is employed in a B-PON system (not depicted), the core 10b of the MCF 10 is connected to a line directed to a subscriber's terminal, the core 10c of the MCF 10 is connected to a video-type device V-OLT on the station side, and the core 20c of the MCF 20 is connected to a data-type device B-OLT (the Internet or the like) on the station side, for example. In thus connected optical multiplexer/demultiplexer 1, signals of λ1, λ2, and λ3 mentioned above serve as an upstream IP signal from the subscriber, a downstream IP signal such as that of the Internet from the station side, and a video-type signal, respectively, for example.

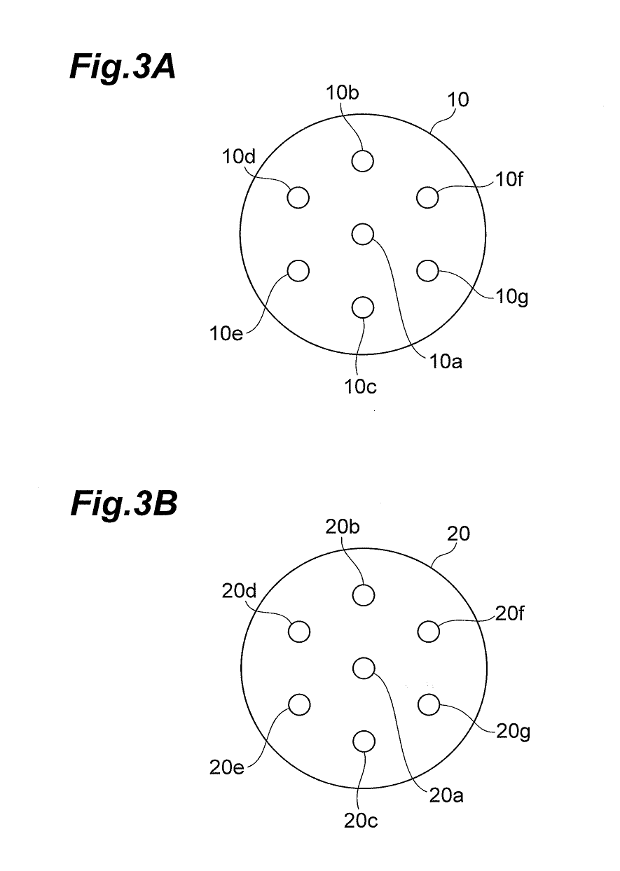

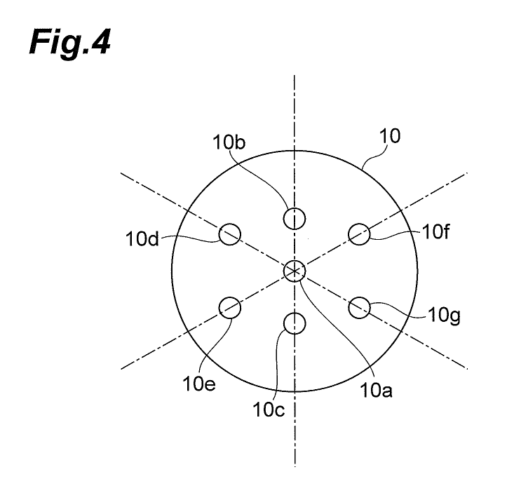

While the above-mentioned example uses only one set constituted by the cores 10b, 10c of the MCF 10 and the core 20c of the MCF 20 in order to simplify the explanation when employed in the B-PON system, one module can act as three sets when each MCF 10, 20 has seven cores. That is, as illustrated in FIGS. 3A and 3B, three sets, i.e., one constituted by the cores 10b, 10c of the MCF 10 and their corresponding core 20c of the MCF 20, one constituted by the cores 10d, 10g of the MCF 10 and their corresponding core 20g of the MCF 20, and one constituted by the cores 10e, 10f of the MCF 10 and their corresponding core 20f of the MCF 20, can be provided within one optical multiplexer/demultiplexer 1. The pairs of cores of the MCF 10 included in each set, which are arranged symmetrically about the center axis of the MCF 10 at the same distance therefrom in the above-mentioned example, may be arranged such that the cores of any pair (e.g., cores 10b, 10c) have a pitch therebetween different from that of cores of another pair (e.g., cores 10d, 10g) as illustrated in FIG. 4.

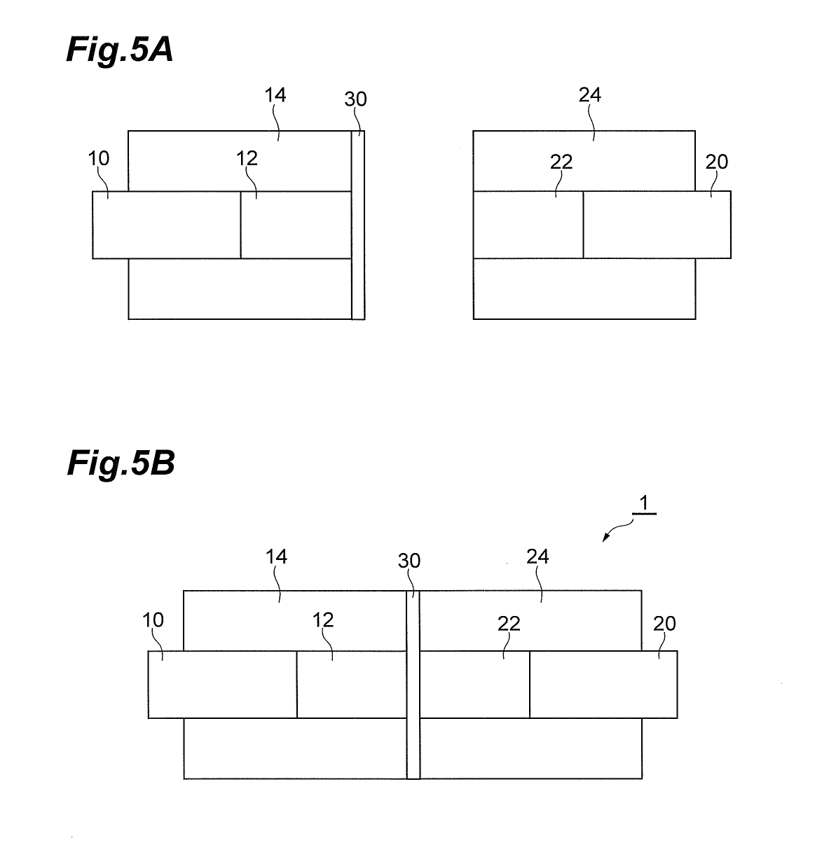

A method of manufacturing the above-mentioned optical multiplexer/demultiplexer 1 will now be explained in brief with reference to FIGS. 5A and 5B.

First, the leading end of the MCF 10 and one end of the GRIN lens 12 are fusion-spliced to each other, and thus fusion-spliced MCF 10 and GRIN lens 12 are arranged within the ferrule 14, so as to form the first fiber unit. On the other hand, the leading end of the MCF 20 and one end of the GRIN lens 22 are fusion-spliced to each other, and thus fusion-spliced MCF 20 and GRIN lens 22 are arranged within the ferrule 24, so as to form the second fiber unit.

Subsequently, as illustrated in FIG. 5A, the optical fiber 30, which is a multilayer filter, is formed by vapor deposition on an end face of the first fiber unit. Then, the first fiber unit having the optical filter 30 vapor-deposited thereon and the second fiber unit are bonded and secured to each other with an adhesive. This forms the optical multiplexer/demultiplexer 1 illustrated in FIG. 5B. The first fiber unit having the optical filter 30 vapor-deposited thereon and the second fiber unit may be firmly attached to each other under load. In this case, the wavelength band to be transmitted/reflected in the optical filter 30 constituted by a multilayer filter shifts under load from that before loading to that after loading as illustrated in FIG. 6, whereby its filter characteristic (transmission characteristic) can be adjusted under load.

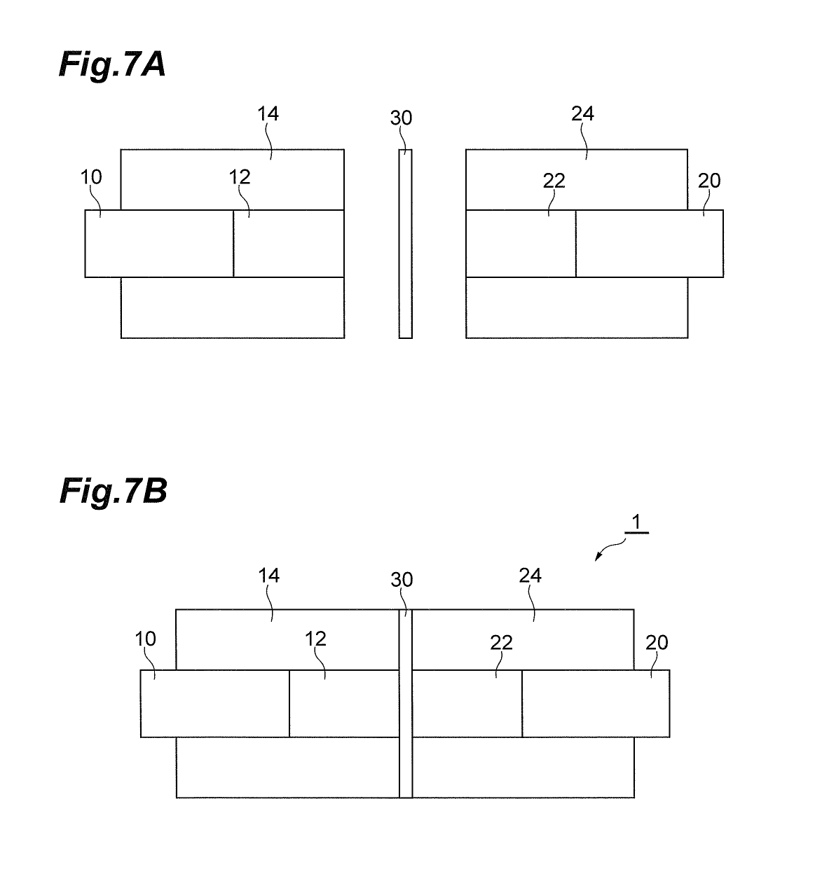

When manufacturing the above-mentioned optical multiplexer/demultiplexer 1, after preparing the first and second fiber units, the optical filter 30 may be disposed between the fiber units as illustrated in FIGS. 7A and 7B, and they may thereafter be secured to each other with an adhesive or under load as mentioned above.

In the optical multiplexer/demultiplexer 1, as explained in the foregoing, the leading end of the MCF 10 and one end of the GRIN lens 12 are held in contact with each other in the first fiber unit, and the leading end of the MCF 20 and one end of the GRIN lens 22 are held in contact with each other in the second fiber unit. The optical filter 30 is disposed between the first and second fiber units thus in contact with each other. Such a structure makes it possible to apply the optical multiplexer/demultiplexer 1 to multicore fibers.

In the optical multiplexer/demultiplexer 1, the leading ends of the MCFs 10, 20 and one ends of the GRIN lens 12, 22 are held in contact with each other in the fiber units. Therefore, the beams emitted from the MCFs 10, 20 are directly incident on the GRIN lenses 12, 22 without passing through air layers and the like, so that reflection losses in beams can be reduced between the leading ends of the MCFs 10, 20 and one ends of the GRIN lenses 12, 22. Thus reducing the reflecting beams can favorably inhibit the reflected beams from returning to the system emitting the same and thereby becoming noises which affect the whole system.

In the optical multiplexer/demultiplexer 1, the MCF 10 and GRIN lens 12 have the same outer diameter, while the MCF 20 and GRIN lens 22 have the same outer diameter. This makes it easy for the MCFs 10, 20 and the GRIN lenses 12, 22 to align their axes with each other.

In the optical multiplexer/demultiplexer 1, the leading ends of the MCFs 10, 20 and one ends of the GRIN lenses 12, 22 are fusion-spliced to each other respectively. This secures the contact between the MCFs 10, 20 and GRIN lenses 12, 22 and restrains them from shifting from each other when in use, for example.

In the optical multiplexer/demultiplexer 1, the MCFs 10, 20 have a core diameter slightly greater in the end parts in contact with the GRIN lenses 12, 22 than in the other part. This makes the core diameter greater in the end parts to become the light entrance ends, whereby the optical axis alignment for making light securely incident can be effected easily without making the optical multiplexer/demultiplexer 1 so large as a whole.

In the optical multiplexer/demultiplexer 1, the cores of the MCF 10 are arranged symmetrically about the center axis of the MCF 10, while a pair of the symmetrically arranged cores have a pitch therebetween identical to that between the cores in another pair. Hence, rotating the MCFs 10, 20 holding the optical filter 30 therebetween about the center axis can provide the optical multiplexer/demultiplexer 1 with a function of an optical switch. In the optical multiplexer/demultiplexer 1, a pair of the symmetrically arranged cores may have a pitch therebetween different from that between the cores in another pair. This prevents a beam from a pair of cores from being made incident on another core, for example.

### Second Embodiment

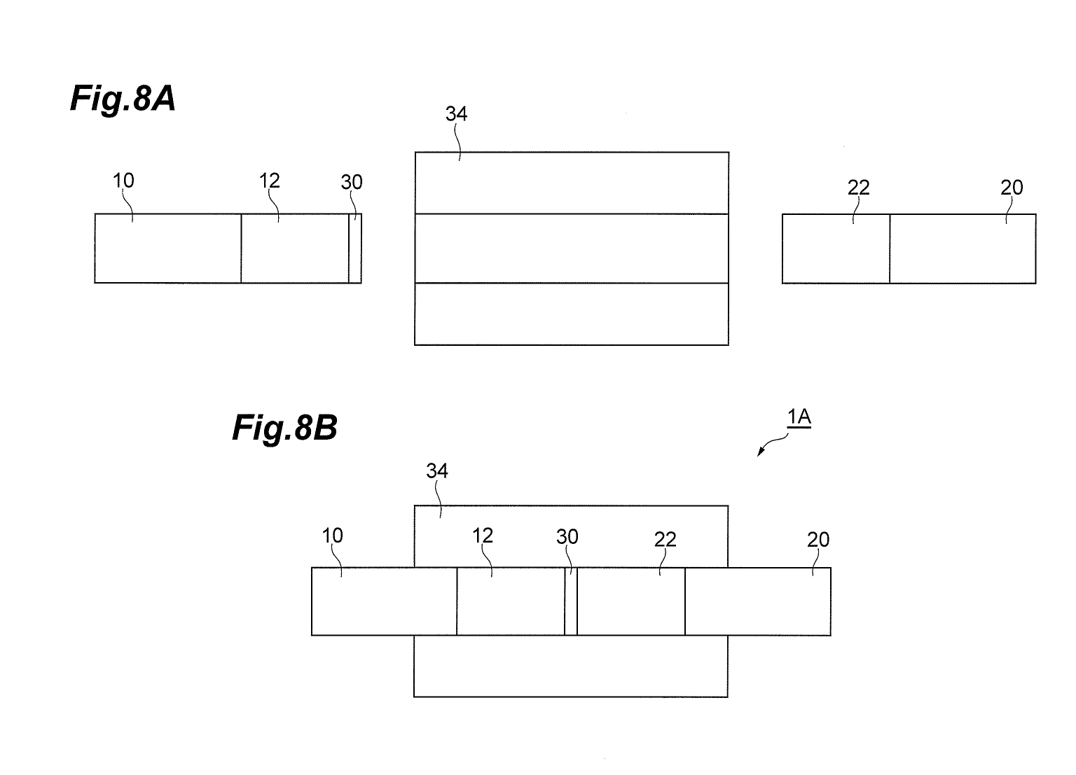

An optical multiplexer/demultiplexer 1A in accordance with the second embodiment of the present invention will now be explained with reference to FIGS. 8A and 8B. The optical multiplexer/demultiplexer 1A in accordance with the second embodiment differs from that of the first embodiment in structures of its ferrule and optical filter, and differences from the first embodiment will mainly be explained in the following.

The optical multiplexer/demultiplexer 1A comprises MCFs 10, 20; GRIN lenses 12, 22; a ferrule 34; and an optical filter 30. In the optical multiplexer/demultiplexer 1A, the MCFs 10, 20, GRIN lenses 12, 22, and optical filter 30 are arranged within the single ferrule 34. In the optical multiplexer/demultiplexer 1A, the optical filter 30 is connected only to end faces of the GRIN lenses 12, 22.

For manufacturing thus constructed optical multiplexer/demultiplexer 1A, a leading end of the MCF 10 and one end of the GRIN lens 12 are initially fusion-spliced to each other, and the optical filter 30 is further formed on the other end of the GRIN lens 12 by vapor deposition or the like. On the other hand, a leading end of the MCF 20 and one end of the GRIN lens 22 are fusion-spliced to each other.

Subsequently, as illustrated in FIG. 8A, the GRIN lens 12 and MCF 10 having the optical filter 30 vapor-deposited thereon and the GRIN lens 22 and MCF 20 are arranged within the single ferrule 34 with an adhesive. Then, the GRIN lens 12 and the like and the GRIN lens 22 and the like are moved toward the center of the ferrule and firmly attached together with the adhesive. They may also be secured under load in this case. This forms the optical multiplexer/demultiplexer 1A. This optical multiplexer/demultiplexer 1A can also exhibit operations and effects similar to those of the above-mentioned first embodiment.

### Third Embodiment

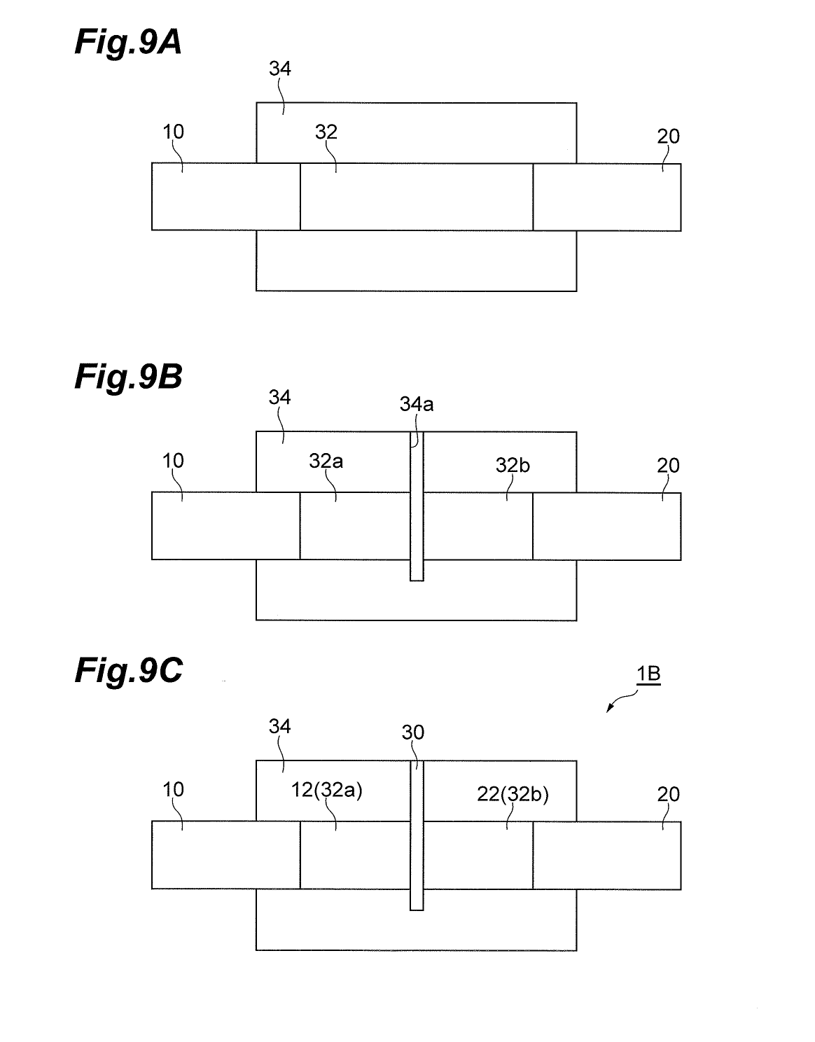

An optical multiplexer/demultiplexer 1B in accordance with the third embodiment of the present invention will now be explained with reference to FIGS. 9A to 9C. The optical multiplexer/demultiplexer 1B in accordance with the third embodiment differs from that of the first embodiment in structures of its ferrule and optical filter, and differences from the first embodiment will mainly be explained in the following.

The optical multiplexer/demultiplexer 1B comprises MCFs 10, 20; GRIN lenses 12, 22; a ferrule 34; and an optical filter 30. In the optical multiplexer/demultiplexer 1B, the MCFs 10, 20, GRIN lenses 12, 22, and optical filter 30 are arranged within the single ferrule 34. In the optical multiplexer/demultiplexer 1B, the optical filter 30 is connected only to end faces of the GRIN lenses 12, 22 and slit surfaces at the center of the ferrule 34.

For manufacturing thus constructed optical multiplexer/demultiplexer 1B, a leading end of the MCF 10 and one end of a common GRIN lens 32 are initially fusion-spliced to each other, and a leading end of the MCF 20 is fusion-spliced to the other end of the common GRIN lens 32. Thus fusion-spliced MCFs 10, 20 and common GRIN lens 32 are then arranged within the ferrule 34.

Subsequently, as illustrated in FIG. 9B, a slit groove 34a extending from the upper end of the ferrule 34 to a location in front of the lower end thereof through the GRIN lens 32 is formed. Forming the slit groove 34a cuts the common GRIN lens 32 into two GRIN lenses 32a, 32b. Then, as illustrated in FIG. 9C, the optical filter 30 is arranged at the slit groove 34a. In this case, the optical filter 30 may or may not be firmly attached to the two GRIN lenses 12 (32a), 22 (32b) with an adhesive. This forms the optical multiplexer/demultiplexer 1B. This optical multiplexer/demultiplexer 1B can also exhibit operations and effects similar to those of the above-mentioned first embodiment.

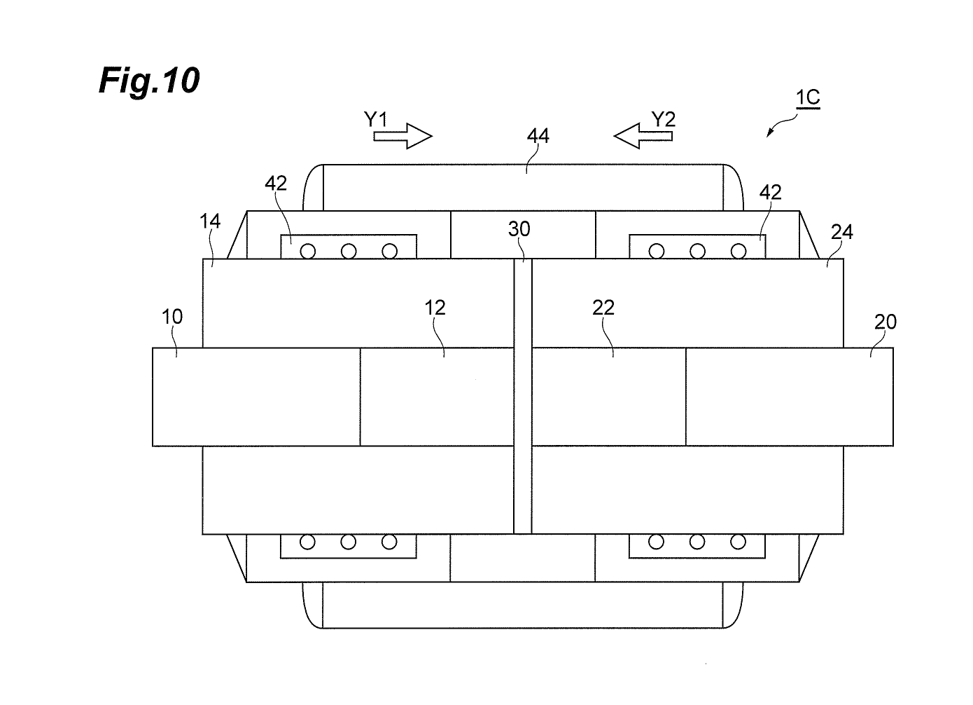

The present invention is not limited to the above-mentioned embodiment, but may be modified in various ways. For example, as illustrated in FIG. 10, an optical multiplexer/demultiplexer 1C may further comprise a connector 44 that holds the first and second fiber units, and the connector 44 may have elastic holding mechanisms 42 that elastically hold the first and second fiber units (GRIN lenses 12, 22 and the like) facing each other through the optical filter 30 under pressure. The elastic holding mechanisms 42 are equipped with springs and urge the GRIN lenses 12, 22 inward by spring pressures as illustrated by depicted arrows Y1, Y2, respectively. Such urging can adjust the optical filter 30 so as to yield a desirable spectrum by its transmission or reflection spectrum shift as mentioned above.

While the above-mentioned embodiments explain cases where the optical multiplexer/demultiplexers 1 to 1C are applied to WDM modules on the station side, they may be applied to WDM modules on the subscriber's terminal side or other optical multiplexer/demultiplexers.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An optical multiplexer/demultiplexer comprising:
a first fiber unit having a first multicore fiber and a first refractive-index-distribution-type optical component;
a second fiber unit having a second multicore fiber and a second refractive-index-distribution-type optical component; and
an optical filter disposed between the first refractive-index-distribution-type optical component of the first fiber unit and the second refractive-index-distribution-type optical component of the second fiber unit, the optical filter configured to make at least one of transmitted light or reflected light emitted from a core of the first multicore fiber incident on a core of the first or second multicore fiber;
wherein a leading end of the first multicore fiber and one end of the first refractive-index-distribution-type optical component are held in contact with each other in the first fiber unit, while a leading end of the second multicore fiber and one end of the second refractive-index-distribution-type optical component are held in contact with each other in the second fiber unit.

2. The optical multiplexer/demultiplexer according to claim 1, wherein the first multicore fiber and first refractive-index-distribution-type optical component have the same outer diameter.

3. The optical multiplexer/demultiplexer according to claim 1, wherein the leading end of the first multicore fiber and the one end of the first refractive-index-distribution-type optical component are firmly attached to each other.

4. The optical multiplexer/demultiplexer according to claim 3, wherein the leading end of the first multicore fiber and the one end of the first refractive-index-distribution-type optical component are fusion-spliced to each other.

5. The optical multiplexer/demultiplexer according claim 1, wherein the first multicore fiber has a core diameter greater in the end part in contact with the first refractive-index-distribution-type optical component than in the other part.

6. The optical multiplexer/demultiplexer according to claim 1, wherein the optical filter is held between the first and second refractive-index-distribution-type optical components under pressure, so as to adjust a transmission characteristic.

7. The optical multiplexer/demultiplexer according to claim 1, further comprising a connector configured to hold the first and second fiber units;
wherein the connector has an elastic holding mechanism that elastically holds the first and second fiber units facing each other under pressure.

8. The optical multiplexer/demultiplexer according to claim 7, wherein the optical filter is adjusted beforehand so as to attain a desirable spectrum by a transmission or reflection spectral shift caused by a spring pressure of the elastic holding mechanism.

9. The optical multiplexer/demultiplexer according to claim 1, wherein a plurality of cores in the first multicore fiber are arranged symmetrically about a center axis of the multicore fiber, a pair of the symmetrically arranged cores having a pitch therebetween identical to that between the cores in another pair.

10. The optical multiplexer/demultiplexer according to claim 1, wherein a plurality of cores in the first multicore fiber are arranged symmetrically about a center axis of the multicore fiber, a pair of the symmetrically arranged cores having a pitch therebetween different from that between the cores in another pair.
